(19) United States
(12) Patent Application Publication
(10) Pub. No.: US 2015/0049580 A1
(43) Pub. Date: Feb. 19, 2015

(54) Imaging Apparatus

(71) Applicant: DolphiTech AS, Raufoss (NO)

(72) Inventors: Eskil Skoglund, Gjovik (NO); Arnt-Børre Salberg, Hamar (NO)

(21) Appl. No.: 14/071,348

(22) Filed: Nov. 4, 2013

(30) Foreign Application Priority Data
Aug. 13, 2013 (GB) 1314481.1

(51) Int. Cl. G01S 7/52

(52) U.S. Cl. CPC G01S 7/52017
USPC 367/7

(57) ABSTRACT

An apparatus for imaging structural features below the surface of an object, comprising: an analysis unit configured to gather information about structural features located at different depths below the surface of the object by transmitting one or more sound pulses at the object and detecting reflections of those sound pulses from the object; and an image generation unit configured to generate: a first image in dependence on a first subset of the detected reflections, the first image representing an overview in which one or more of the structural features may be obscured by another of the structural features; and a second image in dependence on a second subset of the detected reflections, the second image representing a slice through the first image whereby the obscured structural features can be uncovered.

### CROSS-REFERENCE TO RELATED APPLICATIONS

This application claims priority to UK Patent Application No. 1314481.1 entitled Imaging Apparatus, which was filed on Aug. 13, 2013. The disclosure of the foregoing application is incorporated herein by reference in its entirety.

### BACKGROUND

This invention relates to an apparatus for imaging structural features below an object's surface. The apparatus may be particularly useful for imaging sub-surface material defects such as delamination, debonding and flaking.

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled.

Ultrasound may be used to detect and decode machine-readable matrix symbols. Matrix symbols can be directly marked onto a component by making a readable, durable mark on its surface. Commonly this is achieved by making what is in essence a controlled defect on the component's surface, e.g. by using a laser or dot-peening. Matrix symbols can be difficult to read optically and often get covered by a coating like paint over time. The matrix symbols do, however, often have different acoustic impedance properties from the surrounding substrate. U.S. Pat. No. 5,773,811 describes an ultrasound imaging system for reading matrix symbols that can be used to image an object at a specific depth. A disadvantage of this system is that the raster scanner has to be physically moved across the surface of the component to read the matrix symbols. U.S. Pat. No. 8,453,928 describes an alternative system that uses a matrix array to read the reflected ultrasound signals so that the matrix symbol can be read while holding the transducer stationary on the component's surface.

Ultrasound can also be used to identify other structural features in an object. For example, ultrasound may be used for non-destructive testing by detecting the size and position of flaws in an object. The ultrasound imaging system of U.S. Pat. No. 5,773,811 is described as being suitable for identifying material flaws in the course of non-destructive inspection procedures. The system is predominantly intended for imaging matrix symbols so it is designed to look for a “surface”, below any layers of paint or other coating, on which the matrix symbols have been marked. It is designed to image a “surface” at a specific depth, which can be controlled by gating the received signal. The ultrasound system of U.S. Pat. No. 5,773,811 also uses a gel pack to couple ultrasound energy into the substrate, which may make it difficult to accurately determine the depth of features below the substrate's surface.

### SUMMARY

There is a need for an improved apparatus for imaging structural features below the surface of an object.

According to one embodiment of the invention, there is provided an apparatus for imaging structural features below the surface of an object, comprising: an analysis unit configured to gather information about structural features located at different depths below the surface of the object by transmitting one or more sound pulses at the object and detecting reflections of those sound pulses from the object; and an image generation unit configured to generate: a first image in dependence on a first subset of the detected reflections, the first image representing an overview in which one or more of the structural features may be obscured by another of the structural features; and a second image in dependence on a second subset of the detected reflections, the second image representing a slice through the first image whereby the obscured structural features can be uncovered.

The image generation unit may be configured to select which of the detected reflections to use in generating the first and second images in dependence on an ultrasound signal feature associated with each of the detected reflections, such as amplitude, phase and/or a time-of-flight.

The image generation unit may be configured to select which of the detected reflections to use in generating the first and second images in dependence on a respective location on the object's surface at which each reflection was detected.

The image generation unit may be configured to form the second subset to include reflections that are comprised in the first subset but which are not used by the image generation unit to generate the first image.

The first subset may comprise two or more reflections that were triggered by different structural features below the object's surface and were detected at the same location on the object's surface, the image generation unit being configured not to use at least one of the two or more reflections in generating the first image, whereby at least part of the structural feature that triggered the at least one reflection is obscured in the first image.

The image generation unit may be configured to generate the first image to be a two-dimensional or three-dimensional representation of the object and the second image to be a one-dimensional or two-dimensional representation of the object.

The analysis unit may be configured to detect, at a particular location on the object's surface, multiple reflections of the one or more transmitted sound pulses, the image generation unit being configured to generate the first image using fewer of those multiple reflections than the second image.

The image generation unit may be configured to generate the first image using only one of the multiple reflections.

The image generation unit may be configured to generate the first image using the reflection, of the multiple reflections, that has the highest amplitude.

The image generation unit may be configured to generate the second image using two or more of the multiple reflections.

The image generation unit may be configured to generate the first and second images using reflections received at the apparatus during a respective time range, the second image's respective time range being shorter than the first image's respective time range.

The image generation unit may be configured to select reflections to use in generating the first and second images in dependence on a user input.

The image generation unit may be configured to generate the second image to represent a relative depth at which each of the reflections used to generate the image was triggered in the object.

The apparatus may comprise a receiver surface for receiving signals comprising reflections of the one or more transmitted sound pulses, the image generation unit being configured to associate each pixel in the first and/or second image with a location on the receiver surface.

The image generation unit may be configured to select a colour for a pixel in the first and/or second image in dependence on an ultrasound signal feature associated with a reflection received at that pixel's associated location.

The image generation unit may be configured to select a colour for a pixel in dependence on a time-of-flight associated with a reflection received at its associated location.

The image generation unit may be configured to select a colour for a pixel in dependence on an amplitude associated with a reflection received at its associated location.

The image generation unit may be configured to, if a pixel represents a reflection that has an amplitude below a threshold value, associate that pixel with a predetermined value.

The predetermined value may be above the amplitude of the reflection represented by the pixel.

The threshold may be adjustable by the user.

The image generation unit may be configured to set any pixel associated with the predetermined value to be a colour comprised within a particular colour range in the image.

The particular colour range may be grayscale.

The apparatus may comprise a user input module configured to receive a user input selecting one or more pixels in the first image, the image generation unit being configured to generate the second image in dependence on reflections received at the locations on the receiver surface corresponding to the selected pixels.

According to a second embodiment of the invention, there is provided an apparatus for imaging structural features below the surface of an object, comprising: a transmitter unit configured to transmit a sound pulse at the object; a receiver unit configured to receive one or more reflections of that sound pulse from the object; an analysis unit configured to determine a time-of-flight and an amplitude of each of the one or more reflections; and an image generation unit configured to: identify time-of-flights and amplitudes of reflections received from a particular location on the object's surface; and generate an image in dependence on the identified time-of-flights and amplitudes that represents, for each reflection received from the particular location, the amplitude of that reflection and a relative depth below the particular point at which that reflection was triggered in the object.

The image generation unit may be configured to determine the particular location in dependence on user input.

The image generation unit may be configured to generate a plot of an indication of the amplitude of the reflections received at the particular location against an indication of the relative depths of those reflections.

According to a third embodiment of the invention, there is provided an apparatus for imaging structural features below the surface of an object, comprising: a transmitter unit configured to transmit a sound pulse at the object; a receiver unit configured to receive one or more reflections of that sound pulse from the object; an analysis unit configured to determine a time-of-flight and an amplitude of each of the one or more reflections; and an image generation unit configured to: identify time-of-flights and amplitudes of reflections received from a particular line across the object's surface; and generate an image in dependence on the identified time-of-flights and amplitudes, said image representing the variation in amplitude of the reflections received from the particular line and the relative depths below the particular line at which those reflections were triggered.

According to a fourth embodiment of the invention, there is provided an apparatus for imaging structural features below the surface of an object, comprising: a transmitter unit configured to transmit a sound pulse at the object; a receiver unit configured to receive one or more reflections of that sound pulse from the object; an analysis unit configured to determine a time-of-flight and an amplitude of each of the one or more reflections; and an image generation unit configured to: receive a user input that defines a time-of-flight range; identify the amplitudes of reflections that have a time-of-flight in the defined range; and generate a three-dimensional image of a section of the object in dependence on reflections that have those identified amplitudes.

The image generation unit may be configured to generate the three-dimensional image in dependence on the identified amplitudes.

The image generation unit may be configured to generate the three-dimensional image in dependence on the time-of-flights of the reflections having the identified amplitudes.

The apparatus may be configured to simultaneously display two or more different images of the object.

According to a fifth embodiment of the invention, there is provided a method for imaging structural features below the surface of an object, comprising: gathering information about structural features located at different depths below the surface of the object by transmitting one or more sound pulses at the object and detecting reflections of those sound pulses from the object; generating a first image in dependence on a first subset of the detected reflections, the first image representing an overview in which one or more of the structural features may be obscured by another of the structural features; and generating a second image in dependence on a second subset of the detected reflections, the second image representing a slice through the first image whereby the obscured structural features can be uncovered.

### DESCRIPTION OF DRAWINGS

The present invention will now be described by way of example with reference to the accompanying drawings. In the drawings:

FIG. 1 shows an example of an imaging apparatus;

FIG. 2 shows an example of an imaging apparatus in different configurations with respect to an object;

FIG. 3 shows an example of an imaging apparatus;

FIGS. 4a to c show an example of sounds pulses;

FIGS. 5a to c show examples of images;

FIG. 6 shows an example of an imaging process;

FIGS. 7a and b show examples of imaging processes;

FIG. 8 shows an example of an imaging process;

FIG. 9 shows an example of an imaging process;

FIG. 10 shows an example of an imaging process; and

FIG. 11 shows an example of an imaging apparatus.

### DETAILED DESCRIPTION

An imaging apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure he wants to look at is beneath the object's surface. It is therefore important that the information is imaged in such a way that the operator can evaluate the object's structure effectively. To achieve this the imaging apparatus is preferably capable of producing different types of image using the same information.

The first image is generated in dependence on a first subset of reflections. In one example this subset is formed from all of the reflections received from a single transmitted sound pulse. The first image may give an overview of the object: the operator can use it to quickly identify where any potential problems might be. The first image may not be the most useful for identifying individual flaws or where exactly they are located, however, as features can tend obscure one another. Typically this happens when the reflections of two or more different features are detected at the same location on the object's surface. It is not always possible to image all of these reflections so the apparatus may discard some of them for the purposes of the first image. Consequently the structural features that caused the discarded reflections may be wholly or partly obscured in the first image. This is particularly likely when a feature is located behind another on the path of the transmitted sound pulses: its reflections are likely to be discarded as having a lower amplitude and/or a higher time-of-flight than the feature in front of it.

The imaging apparatus may generate a second image to address the obscuring issue by filtering out some of the reflections in the first subset to create a second subset. The second subset might also include some reflections that were not in the first subset. The imaging apparatus suitably uses all of the second subset to generate the second image so that all of the structural features that triggered those reflections are represented. Features that were obscured in the first image can be uncovered in the second image. The first and second subsets may be formed using a wide range of different selection criteria, such as amplitude, time-of-flight, location of receipt etc.

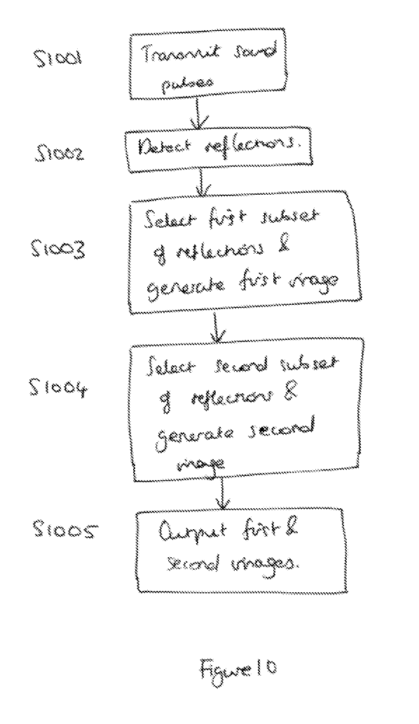

A process that may be performed by an imaging apparatus is shown in FIG. 10. The apparatus transmits sound pulses and detects their reflections (S1001, S1002). It selects a first subset of the detected reflections and generates a first image (S1003). It then generates a second subset of the detected reflections and generates a second image (S1004). The apparatus then outputs the first and second images, preferably at the same time (S1005).

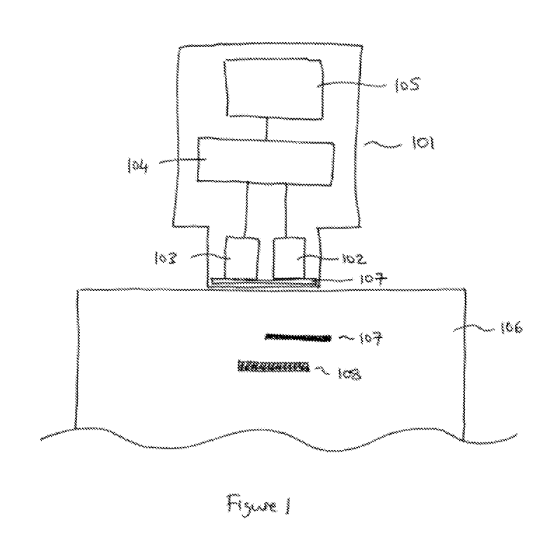

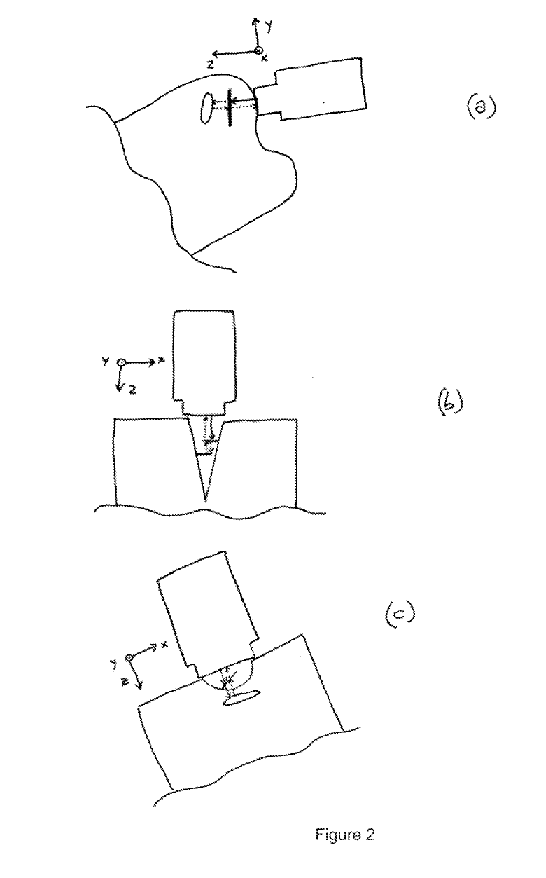

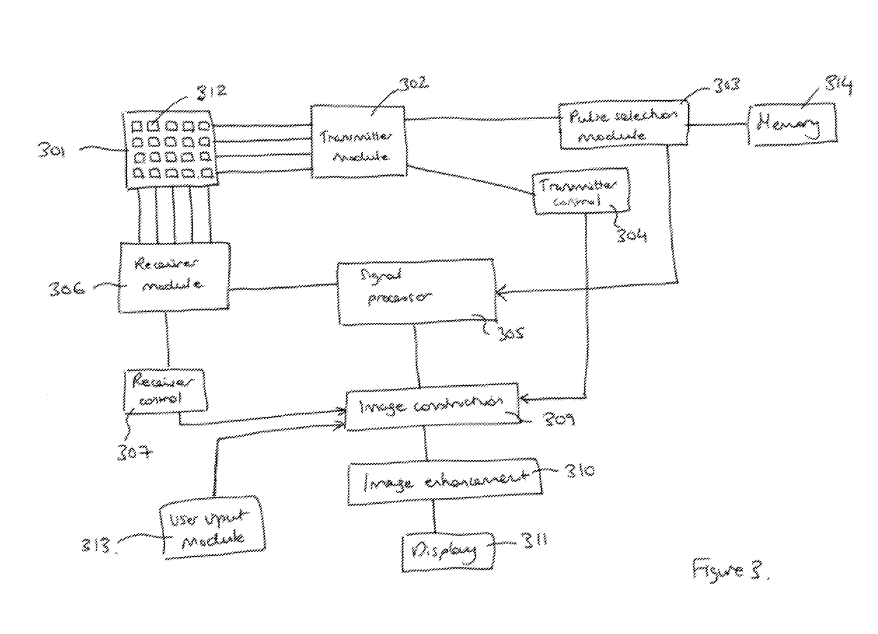

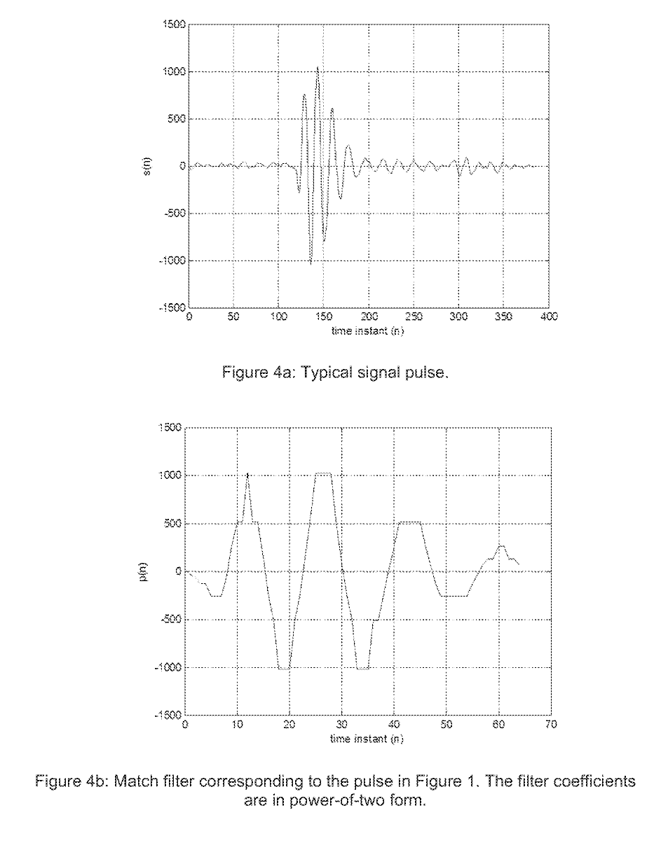

An apparatus for imaging structural features below the surface of an object comprising structural features 107, 108 is shown in FIG. 1. The apparatus, shown generally at 101, comprises an analysis unit 104 and an image generation unit 105. The analysis unit further comprises a transmitter unit 102 and a receiver unit 103. The transmitter and receiver units are shown next to each other in FIG. 1 for ease of illustration only. In a practical realisation of a transducer it is likely that the transmitter and receiver units will be implemented as layers one on top of the other. The transmitter unit is suitably configured to transmit a sound pulse having a particular shape at the object to be imaged 106. The receiver unit is configured to receive reflections of transmitted sound pulses and suitably has a receiver surface 109 for receiving reflections across the object's surface.

Typically the receiver unit receives multiple reflections of the transmitted sound pulse. The reflections are caused by features of the material structure below the object's surface. Reflections are caused by impedance mismatches between different layers of the object, e.g. a material boundary at the join of two layers of a laminated structure. Often only part of the transmitted pulse will be reflected and a remainder will continue to propagate through the object (as shown in FIGS. 2a to c). The remainder may then be wholly or partly reflected as it encounters other features in the material structure. This model of reflection and propagation is most likely to occur in solid sections of the object. There are two reasons for this: (i) ultrasound is attenuated strongly by air; and (ii) air-object boundaries tend to show a big impedance mismatch, so that majority of ultrasound encountering an air-object boundary will be reflected.

FIGS. 2a to c show examples of structural features that are not contained within the solid body of the object. The features could be contained within a hole, depression or other hollow section. Such features are considered to be “in” the object and “below” its surface for the purposes of this description because they lie on the path of the sound pulses as they travel from the apparatus through the object.

Structural features that are located behind other features are generally “invisible” to existing imaging systems. Analysis unit 104, however, may be configured to detect the reflections caused by both of the structural features shown in FIG. 1 (107, 108). The analysis unit is also configured to associate each recognised reflection with a relative depth below the object's surface. This information enables image generation unit 105 to generate an image that represents both the first and second structural features. The image may be displayed for an operator, enabling sub-surface features to be detected and evaluated. This enables the operator to see into the object in the direction of the transmitted pulses and can provide valuable information on sub-surface material defects such as delamination, debonding and flaking.

There are a number of ways in which the apparatus may be configured to identify reflections from structural features that are obscured by other features closer to the surface. One option is to use different transmitted sound pulses to gather information on each structural feature. These sound pulses might be different from each other because they are transmitted at different time instants and/or because they have different shapes or frequency characteristics. The sound pulses might be transmitted at the same location on the object's surface or at different locations. This may be achieved by moving the apparatus to a different location or by activating a different transmitter in the apparatus. If changing location alters the transmission path sufficiently a sound pulse might avoid the structural feature that, at a different location, had been obscuring a feature located farther into the object. Another option is to use the same transmitted sound pulse to gather information on the different structural features. This option uses different reflections of the same pulse. The apparatus may implement any or all of the options described above and may combine data gathered using any of these options to generate a sub-surface image of the object. The image may be updated and improved on a frame-by-frame basis as more information is gathered on the sub-surface structural features.

A more detailed view of an imaging apparatus is shown in FIG. 3. In this example the transmitter and receiver are implemented by an ultrasound transducer 301, which comprises a matrix array of transducer elements 312. These transducer elements form the receiver surface. The transmitter electrodes are connected to the transmitter module 302, which supplies a pulse pattern with a particular shape to a particular electrode. The transmitter control 304 selects the transmitter electrodes to be activated. The receiver electrodes sense sound waves that are emitted from the object. The receiver module 306 receives and amplifies these signals.

The transmitter may transmit the sound pulses using signals having frequencies between 100 kHz and 30 MHz, preferably between 1 and 15 MHz and most preferably between 2 and 10 MHz.

The pulse selection module 303 selects the particular pulse shape to be transmitted. It may comprise a pulse generator 313, which supplies the transmitter module with an electronic pulse pattern that will be converted into ultrasonic pulses by the transducer. The pulse selection module may have access to a plurality of predefined pulse shapes stored in memory 314.

The signal processor 305 may form part of the analysis unit shown in FIG. 1. It detects reflected sound pulses in the received signal. It also extracts relevant information from the reflections. The signal is suitably time-gated so that the signal processor only detects and processes reflections from depths of interest. The time-gating may be adjustable, preferably by a user, so that the operator can focus on a depth range of interest. The depth range is preferably 0 to 20 mm, and most preferably 0 to 15 mm. The signal processor may receive a different signal from each location on the receiver surface, e.g. each transducer in the electrode. The signal processor may analyse these signals sequentially or in parallel.

The signal processor suitably detects the reflected pulses by comparing the received signal with an expected, reflected pulse shape. This may be achieved using a match filter corresponding to the transmitted pulse. The apparatus may be arranged to accumulate and average a number of successive samples in the incoming sample (e.g. 2 to 4) for smoothing and noise reduction before the filtering is performed. The analysis unit uses the match filter to accurately determine when the reflected sound pulse was received. The signal processor performs features extraction to capture the maximum amplitude of the filtered signal and the time at which that maximum amplitude occurs. The signal processor may also extract phase and energy information.

The signal processor is preferably capable of recognising multiple peaks in each received signal. It may determine that a reflection has been received every time that the output of the match filter exceeds a predetermined threshold. It may identify a maximum amplitude for each acknowledged reflection.

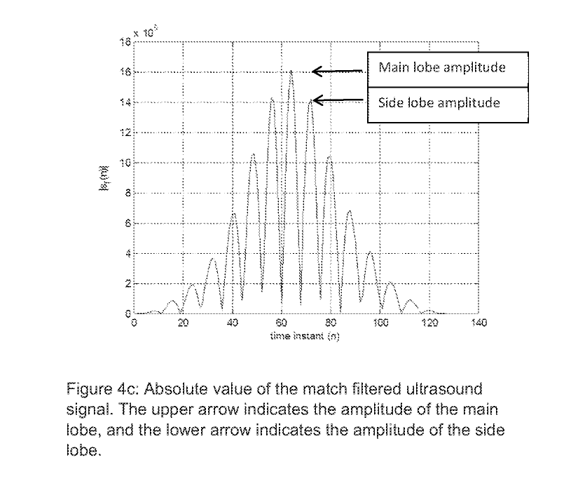

Examples of an ultrasound signal s(n) and a corresponding match filter p(n) are shown in FIGS. 4a and b respectively. The ultrasound signal s(n) is a reflection of a transmitted pulse against air. The absolute values of the filtered time series (i.e. the absolute of the output of the match-filter) for ultrasound signal s(n) and corresponding match filter p(n) are shown in FIG. 4c. The signal processor estimates the time-of-flight as the time instant where the amplitude of the filtered time series is at a maximum. In this example, the time-of-flight estimate is at time instant 64.

In one embodiment the apparatus may amplify the filtered signal before extracting the maximum amplitude and time-of-flight values. This may be done by the signal processor. The amplification steps might also be controlled by a different processor or FPGA. In one example the time corrected gain is an analogue amplification. This may compensate for any reduction in amplitude that is caused by the reflected pulse's journey back to the receiver. One way of doing this is to apply a time-corrected gain to each of the maximum amplitudes. The amplitude with which a sound pulse is reflected by a material is dependent on the qualities of that material (for example, its acoustic impedance). Time-corrected gain can (at least partly) restore the maximum amplitudes to the value they would have had when the pulse was actually reflected. The resulting image should then more accurately reflect the material properties of the structural feature that reflected the pulse. The resulting image should also more accurately reflect any differences between the material properties of the structural features in the object.

The signal processor may be configured to adjust the filtered signal by a factor that is dependent on its time-of-flight.

The image construction module 309 and image enhancement module 310 may form part of the image generation unit shown in FIG. 1. The image construction module may be configured to receive user input from user input module 313. Generated images are output to display 311, which may be contained in the same device or housing as the other components or in a separate device or housing. The display may be linked to the other components via a wired or wireless link.

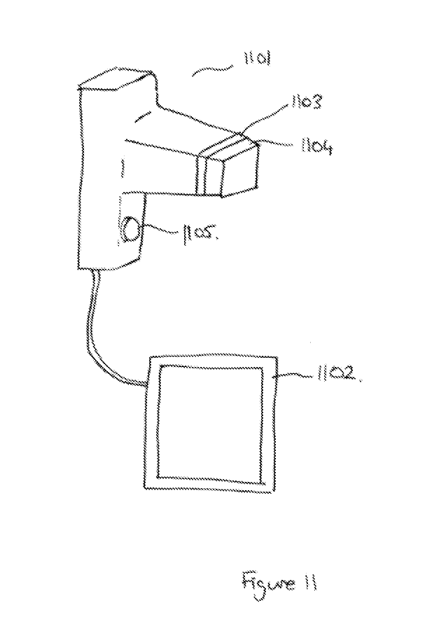

Some or all of the image construction module and the image enhancement module could be comprised within a different device or housing from the transmitter and receiver components, e.g. in a tablet, PC, phone, pda or other computing device. However, it is preferred for us much as possible of the image processing to be performed in the transmitter/receiver housing (see e.g. handheld device 1101 in FIG. 11).

The image construction module may generate a number of different images using the information gathered by the signal processor. Any of the features extracted by the signal processor from the received signal may be used. Typically the images represent the time-of-flight and energy or amplitude. The image construction module may associate each pixel in an image with a particular location on the receiver surface so that each pixel represents a reflection that was received at the pixel's associated location.

The image construction module may be able to generate an image from the information gathered using a single transmitted pulse. The image construction module may update that image with information gathered from successive pulses. The image construction module may generate a frame by averaging the information for that frame with one or more previous frames so as to reduce spurious noise. This may be done by calculating the mean of the relevant values that form the image.

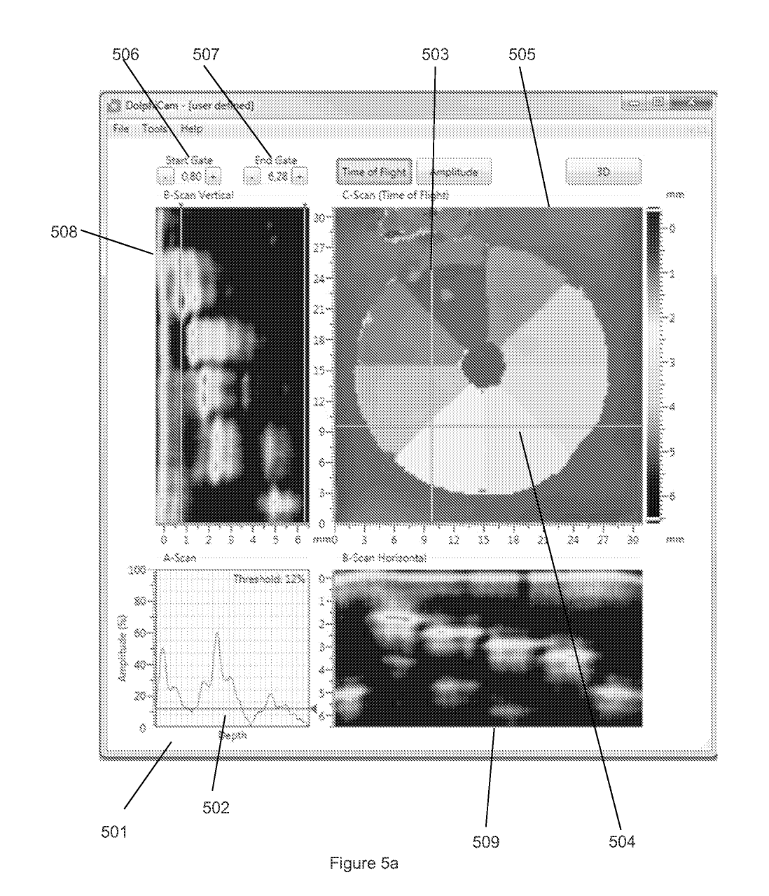

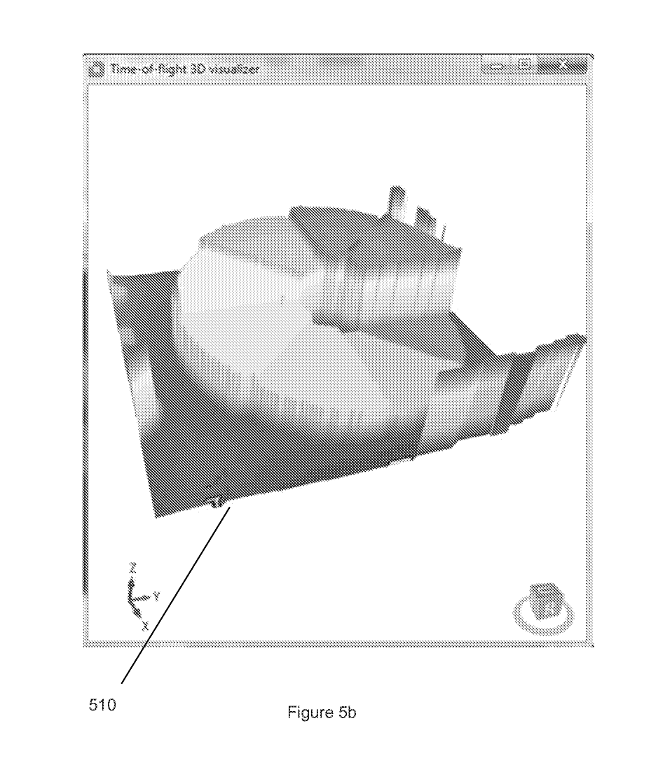

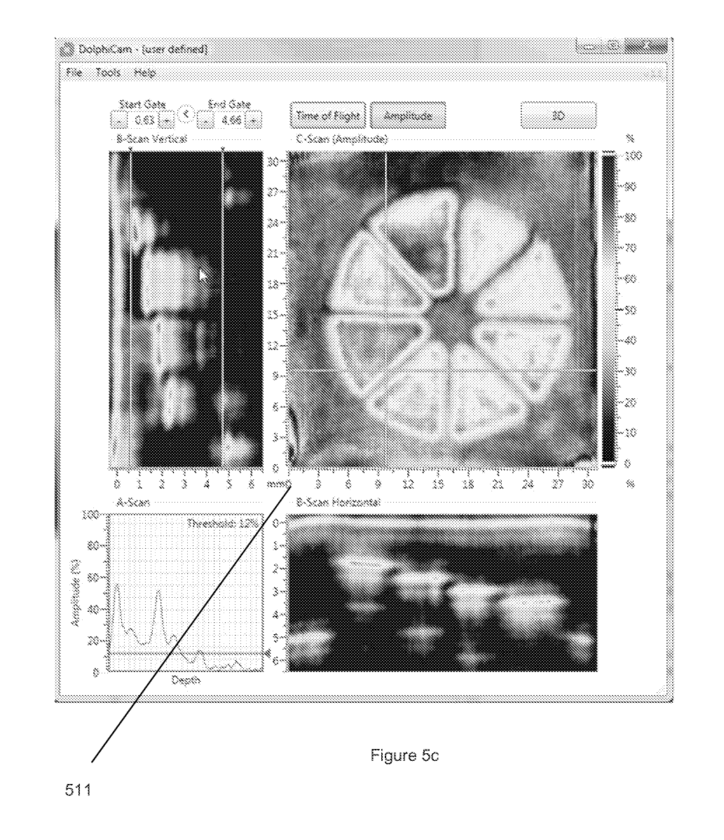

The image enhancement module 310 enhances the generated images to reduce noise and improve clarity. The image processing module may process the image differently depending on the type of image. (Some examples are shown in FIGS. 5a to c and described below.) The image enhancement module may perform one or more of the following:
Time Averaging. Averaging over the current and the previous frame may be performed by computing the mean of two or more successive frames for each point to reduce spurious noise.
Background compensation. The background image is acquired during calibration by transmitting a sound pulse at air. All the reflected pulse-peaks toward air are converted to the range [0, 1]. This is a digital compensation and most values will be converted to 1 or nearly 1. The ultrasound camera (e.g. the ultrasound transducer in the example of FIG. 3) inherently has some variations in performance across its surface that will affect the time and amplitude values extracted by the signal processor. To compensate for this, images obtained during normal operation are divided by the background image.
Signal envelope estimation. An analytic representation of the background compensated signal may be created as the sum of the signal itself and an imaginary unit times the Hilbert transform of the signal. The analytic signal is a complex signal, from which the signal envelope can be extracted as the magnitude of the analytic signal and used in further processing. Generation of low-amplitude mask. This process may be used particularly for generating 3D images. A mask covering pixels that have amplitude values lower than a threshold is created. (This threshold may be lower than the threshold value for the thresholding described below.) A filter such as a 3×3 maximum filter is then used on the resulting mask to close small holes.
Thresholding: A threshold percentage can be specified so that low amplitude values do not clutter the image. In some embodiments this may be set by the operator. A threshold value is calculated from the percentage and the total range of the amplitude values. Parts the image having an amplitude value lower than this threshold are truncated and set to the threshold value. A threshold percentage of zero means that no thresholding is performed. The purpose of the thresholding is to get a cleaner visualization of the areas where the amplitude is low.
Normalization: The values are normalized to the range 0-255 to achieve good separation of colours when displayed. Normalization may be performed by percentile normalization. Under this scheme a low and a high percentile can be specified, where values belonging to the lower percentile are set to 0, values belonging to the high percentile are set to 255 and the range in between is scaled to cover [0, 255]. Another option is to set the colour focus directly by specifying two parameters, colorFocusStartFactor and colorFocusEndFactor, that define the start an end points of the range. The values below the start factor are set to 0, values above the end factor is set to 255 and the range in between is scaled to cover [0, 255].
Filtering. Images may be filtered to reduce spurious noise. Care should to be taken that the resulting smoothing does not to blur edges too much. The most appropriate filter will depend on the application. Some appropriate filter types include: mean, median, Gaussian, bilateral and maximum similarity.
Generation of colour matrix. A colour matrix is created that specifies values from the grey-level range of the colour table for low-amplitude areas and values from the colour range for the remaining, higher-amplitude areas. A mask for the grey level areas may be obtained from an eroded version of the low-amplitude mask. (The erosion will extend the mask by one pixel along the edge between grey and colour and is done to reduce the rainbow effect that the visualization would otherwise create along the edges where the pixel value goes from the grey level range to the colour range.)

Examples of the images that may be produced by the image generation unit are described below.

### A-Scan

The A-scan is one-dimensional. It images the reflections at all sampled depths for a particular location on the object's surface. The A-scan represents the amplitude of the reflections at that particular location and the depth at which those reflections were triggered.

The apparatus may detect the reflections by analysing the signal received at a particular location on its own receiving surface, e.g. the signal received by a particular electrode in an ultrasound transducer.

An example of an A-scan is shown at 501 in FIG. 5a. This example is a straightforward plot of amplitude against depth. Depth is calculated from the time-of-flight information. The peaks represent structural features that reflected the sound pulses. The cross hairs 503,504 designate the particular location that is represented by the A-scan. This point is an x,y location (see the axes in FIGS. 2a to c and FIG. 5b).

The operator is suitably able to select the particular location. In the example shown in FIG. 5a this may be done by moving the cross hairs 503, 504. The threshold percentage may also be set by the operator. In FIG. 5a, this may be done by moving horizontal slidebar 502.

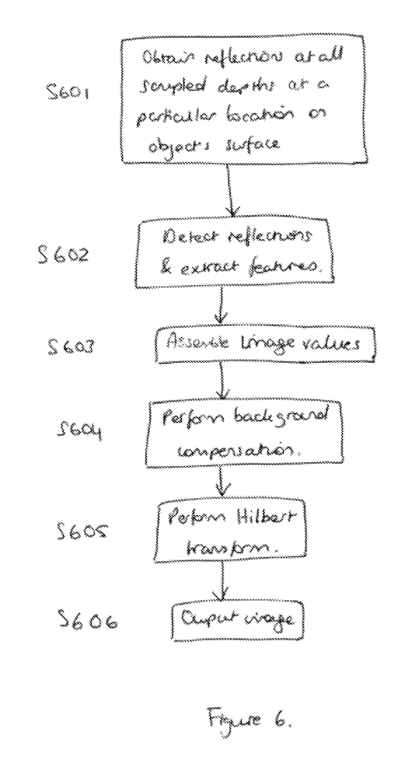

An example of a process for generating an A-scan is shown in FIG. 6. The image enhancement module may perform background compensation (S604) and the signal envelope estimation (S605) as part of generating the A-scan. The A-scan could image the unfiltered signal or the filtered signal but it is generally easier to interpret a signal envelope as it only has one “peak”. An unfiltered will have several “peaks” and might be more difficult to interpret.

The A-scan provides an operator with precise, detailed information about the structure below a particular location on the object's surface. Features may be identifiable in the A-scan that would be obscured in other images. It enables the operator to focus exclusively on a small target area of interest. It also enables the operator to identify that a particular area of the object may be worth further investigation. The operator may use this information to work out where he should “slice” through other images to uncover and focus on the part of the object he wants to look at. The A-scan may also be used to “clean up” other images of the object since it enables the operator to blank out low amplitude reflections in the other scans by moving the horizontal slidebar.

### C-Scan Time-of-Flight or Amplitude

The C-scan time-of-flight and amplitude scans are two-dimensional. They image the reflections at sampled depths across the object's surface. The scan may image time-of-flight, amplitude, signal energy or any other extracted feature.

The apparatus detects reflections across the object's surface. Suitably each pixel in the image represents a reflection received at particular point on its receiving surface, e.g. at a particular electrode in an ultrasound transducer. Depending on the depth being sampled, the apparatus may receive multiple reflections at a particular point on its receiving surface. Typically the scan will image the reflection having the maximum amplitude. This means that structural features that caused smaller reflections might be obscured in the resulting image.

An example of a time-of-flight scan is shown at 505 in FIG. 5a. It represents time-of-flight, i.e. each pixel is allocated a colour according to the relative depth associated with the largest reflection received at that location on the object's surface. An example of an amplitude scan is shown at 511 in FIG. 5c. The scans are similar to a plan view looking into the object from the perspective of the imaging apparatus. They effectively image a sub-surface “layer” of the object that is largely parallel to the receiving surface of the apparatus (which in turn will usually conform to the surface of the object it is pressed against). The “layer” may be discontinuous, however, as parts of the scan may image features located at a different depth from features shown in other parts of the image, depending on what features have triggered the largest amplitude reflections.

The operator can use cross hairs 503, 504 to look at particular slices through the scans (this generates the B-scans discussed below). The illustrated cross-hairs are straight lines parallel to the x and y axes of the scans. This is for the purposes of example only; the operator may be able to slice along lines that are angled to the axes or lines that are curved. The upper and lower gates 506, 507 are used to set the upper and lower bounds for time gating the incoming signals. The operator may be able to achieve a greater colour contrast between structural features of interest by adjusting the gates to focus on the depth of interest. The operator may also select only a certain depth area to inspect by adjusting the gates.

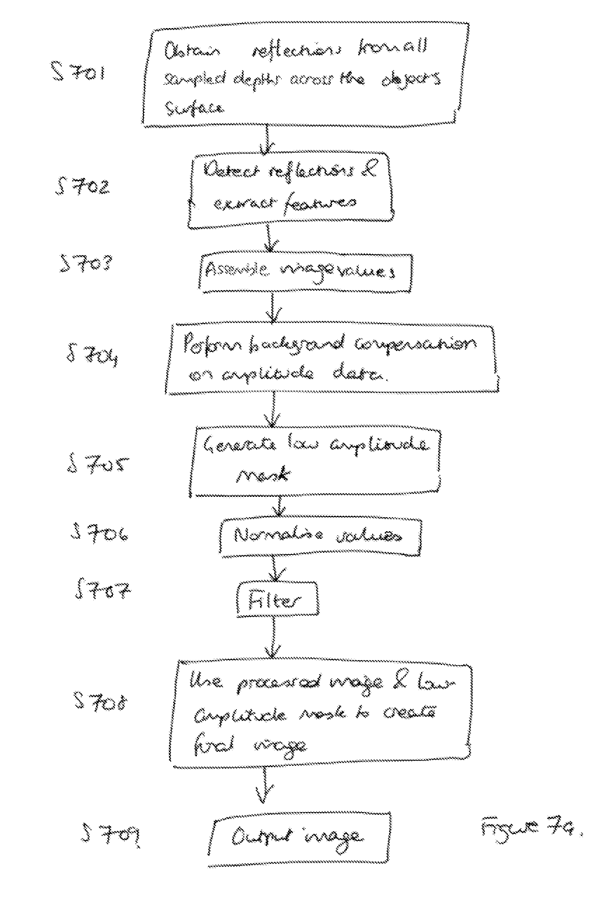

The time-of-flight and amplitude images are processed slightly differently. An example of the process for a time-of-flight image is shown in FIG. 7a. The main steps are normalization of values (optional) and spatial median filtering. A-low amplitude mask is used because even though this is a time-of-flight image, amplitude data is still used for visualisation. The image enhancement module typically starts by performing background compensation (S704). This is adjusts the amplitude data only. A low-amplitude mask may then be generated to cover pixels that have amplitude values lower than a threshold (S705). This threshold may be the level set by the horizontal slidebar in the A-scan. The time-of-flight/amplitude values are then normalized (S706) and filtered (S707). A suitable filter might be a 3×3 spatial median filter. The low-amplitude mask is returned along with the processed image to enable visualisation in the image of points having an amplitude lower than the threshold (S708). The points covered by the mask could, for example, be visualised using the grey scale whereas points outside the mask may be visualised using the colour scale.

An example of the process for an amplitude image is shown in FIG. 7b. The main steps are background compensation, thresholding and normalization. The image enhancement module typically starts by performing background compensation (S713). Thresholding is then performed using the level set by the horizontal slidebar in the A-scan (S714). Points with amplitudes below the threshold are truncated and set to the amplitude value. The time-of-flight/amplitude values are then normalized (S715).

The time-of-flight and amplitude scans provide the operator with a good overview of the structure below an object's surface. They provide the operator with an indication of what sections of the object might warrant further investigation. Some structural features may be obscured, but these can be uncovered by “slicing” into the time-of-flight and amplitude scans. This slicing can either be perpendicular to the time-of-flight and amplitude scan and into the object (e.g. by using the cross hairs) or it can be across the time-of-flight and amplitude scan (e.g. by using time-gating).

### B-Scan

The B-scan is also two-dimensional. It represents the reflections received along a particular line across the object's surface. The B-scan images the variation in amplitude of the reflections received along the particular line and their relative depths. The B-scan looks into the object. It can be used to uncover features that are obscured in other images, such as the time-of-flight and amplitude scans.

The apparatus may detect reflections received from the object along a corresponding line on its own receiving surface. This may be a line of electrodes in an ultrasound transducer. The apparatus may receive multiple reflections at one or more points along the line. The B-scan is only interested in one dimension along the object's surface so the scan's second dimension goes into the object. The B-scan is therefore able to represent the multiple reflections.

FIG. 5a shows two different B-scans. The B-scan is comprised of two separate two-dimensional images that represent a vertical view (y,z) 508 and a horizontal view (x,z) 509. The vertical and horizontal views image into the object. The colours allocated to each pixel represent the sound energy reflected at that location and depth. The cross hairs 503, 504 determine where the “slice” through the plan view 505 is taken. As mentioned above, the operator may also be able to slice along lines that are angled to the axes or lines that are curved. The upper and lower gates 506, 507 are used to set the upper and lower bounds for time gating the incoming signals. The operator may be able to achieve a greater colour contrast between structural features of interest by adjusting the gates to focus only on the depth of interest. The operator may also select only a certain depth range to inspect by adjusting the gates.

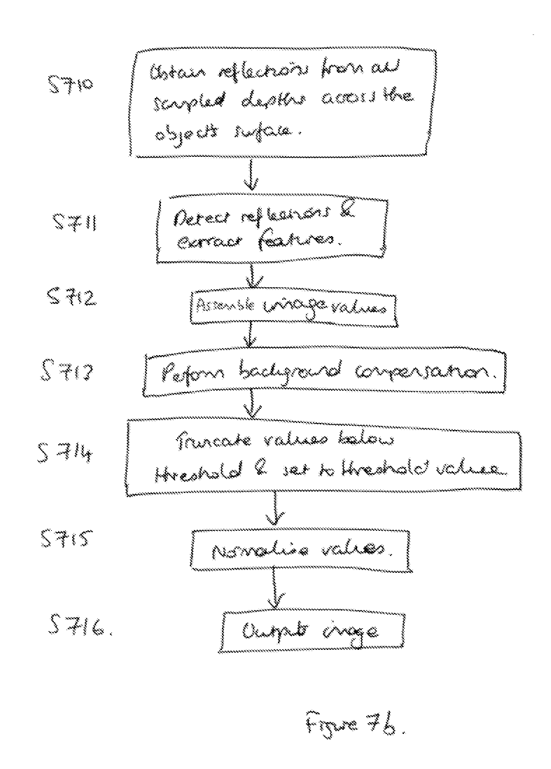

The process of generating a B-scan is shown in FIG. 8. The main steps performed by the image enhancement module in producing a B-scan are: time averaging (S804), background compensation (S805), a signal envelope estimation (S808), thresholding (S809) and normalization (S810) (optional). The horizontal and vertical scans are generated via the same process with one exception: the signal envelope estimation is performed on the transposed background compensated image for the horizontal scan (S806, S807).

The B-scans give the operator a good idea of the size, depth and position of sub-surface structural features lying along a particular line on the object's surface. They may uncover features that are obscured in other scans.

### Three-Dimensional

The three-dimensional image is similar to the time-of-flight and amplitude scans in that it images the reflections at sampled depths across the object's surface. Some features may be obscured.

FIG. 5b shows an example of a 3D image 510. The operator may be able to rotate and zoom-in to the image. The operator can select to view a sub-surface layer of a particular thickness by adjusting the time gates 506, 507.

Creating three-dimensional images can require more noise reduction than for two-dimensional images. The reason for this is that noise can appear as tall spikes in the three-dimensional images, causing shadows and making it difficult to see the true structures.

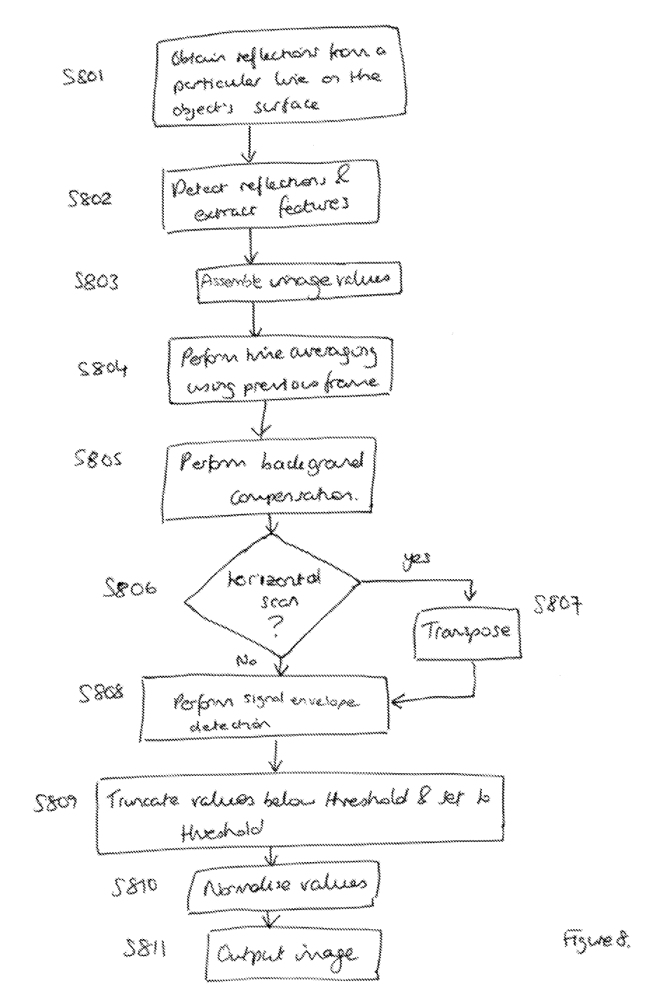

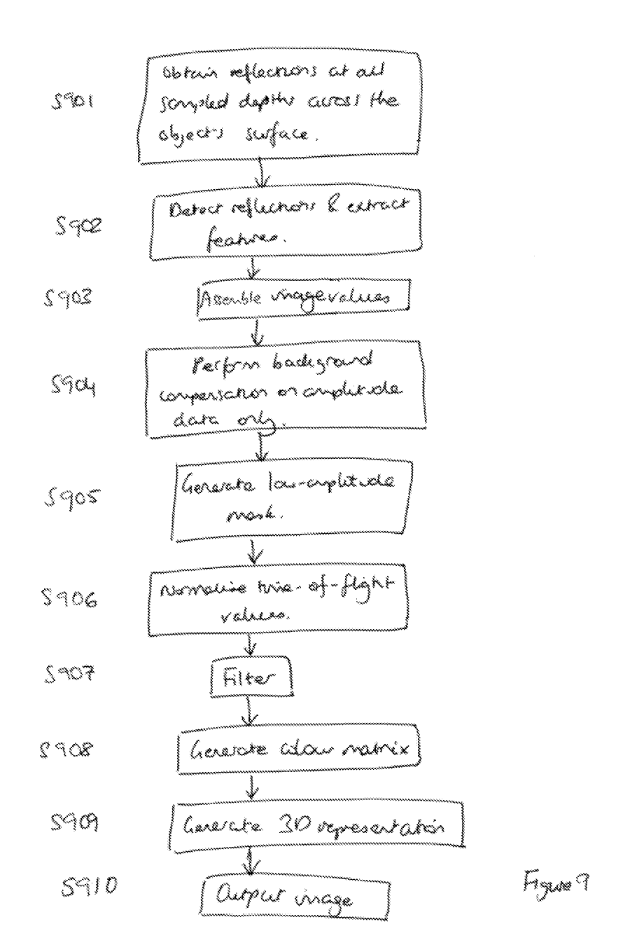

A process for generating a three-dimensional image is shown in FIG. 9. The image undergoes background compensation (S904). A low amplitude mask is then generated (s905), which usually has a threshold lower than that specified in the A-scan GUI. A maximum filter may be used on the mask to close any small holes. The image then undergoes normalisation (optional) (S906) and spatial filtering (S907). It is then combined with a generated colour matrix (S908). The colour matrix specifies values from the grey-level range of the colour table for low-amplitude areas and values from the colour range for other amplitudes (this only applies when the amplitude threshold is used). Note that it is possible to set the colours independently of the time-of-flight values. The three dimensional representation is created from the filtered image in combination with the low-amplitude mask (S909). Points outside the mask are assigned a height in the three-dimensional image corresponding to their time-of-flight value. They are also assigned a corresponding colour value. Points inside the mask are assigned a height corresponding to the furthest point being imaged and a grey colour corresponding to their time-of-flight value. In this way the C-scan displays information about both which points have been suppressed and their original values.

The C-scan provides the operator with a user-friendly representation of what the object looks like below its surface. It is the scan that provides the user with an experience closest to looking directly at a sub-surface part of the object. It may be the scan that the operator uses most often to visualise potential problem areas below the surface of the object, such as potential stress concentrators. Obscured features may be uncovered either by changing the time-gating the received signals or by using one of the other scans.

An example of a handheld device for imaging below the surface of an object is shown in FIG. 11. The device 1101 could have an integrated display, but in this example it outputs images to a tablet 1102. The connection with the tablet could be wired, as shown, or wireless. The device has a matrix array 1103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus comprises a dry coupling layer 1104 for coupling ultrasound signals into the object. The dry coupling layer also delays the ultrasound signals to allow time for the transducers to switch from transmitting to receiving. A dry coupling layer offers a number of advantages over other imaging systems, which tend to use liquids for coupling the ultrasound signals. This can be impractical in an industrial environment. If the liquid coupler is contained in a bladder, as is sometimes used, this makes it difficult to obtain accurate depth measurements which is not ideal for non-destructive testing applications.

The matrix array 1103 is two dimensional so there is no need to move it across the object to obtain an image. A typical matrix array might be 30 mm by 30 mm but the size and shape of the matrix array can be varied to suit the application. The device may be straightforwardly held against the object by the operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 1105 that the operator can use to change the pulse shape and corresponding filter. The most appropriate pulse shape may depend on the type of structural feature being imaged and where it is located in the object. The operator views the object at different depths by adjusting the time-gating via the display (see also FIG. 5a, described above). Having the apparatus output to a handheld display, such as tablet 1102, or to an integrated display, is advantageous because the operator can readily move the transducer over the object, or change the settings of the apparatus, depending on what he is seeing on the display and get instantaneous results. In other arrangements, the operator might have to walk between a non-handheld display (such as a PC) and the object to keep rescanning it every time a new setting or location on the object is to be tested.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly suitable for applications where it is desired to image a small area of a much larger component. The apparatus is lightweight, portable and easy to use. It can readily carried by hand by an operator to be placed where required on the object.

The imaging apparatus described herein is capable of generating a number of different images of the structural features below an object's surface. Two or more of these images may be advantageously displayed simultaneously (as shown in FIGS. 5a to c), which makes it straightforward for the operator to compare the images and form a complete picture of what is going on below the object's surface. The apparatus is also advantageously capable of creating the images from the same information, meaning that there is no need for the operator to rescan the object.

The functional blocks illustrated in the figures represent the different functions that the apparatus is configured to perform; they are not intended to define a strict division between physical components in the apparatus. The performance of some functions may be split across a number of different physical components. One particular component may perform a number of different functions. The functions may be performed in hardware or software or a combination of the two. The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An apparatus for imaging structural features below the surface of an object, comprising:
an analysis unit configured to gather information about structural features located at different depths below the surface of the object by transmitting one or more sound pulses at the object and detecting reflections of those sound pulses from the object; and
an image generation unit configured to generate:
a first image in dependence on a first subset of the detected reflections, the first image representing an overview in which one or more of the structural features may be obscured by another of the structural features; and
a second image in dependence on a second subset of the detected reflections, the second image representing a slice through the first image whereby the obscured structural features can be uncovered.

2. An apparatus as claimed in claim 1, the image generation unit being configured to select which of the detected reflections to use in generating the first and second images in dependence on an ultrasound signal feature associated with each of the detected reflections.

3. An apparatus as claimed in claim 1, the image generation unit being configured to select which of the detected reflections to use in generating the first and second images in dependence on a respective location on the object's surface at which each reflection was detected.

4. An apparatus as claimed in claim 1, the image generation unit being configured to form the second subset to include reflections that are comprised in the first subset but which are not used by the image generation unit to generate the first image.

5. An apparatus as claimed in claim 1, wherein the first subset comprises two or more reflections that were triggered by different structural features below the object's surface and were detected at the same location on the object's surface, the image generation unit being configured not to use at least one of the two or more reflections in generating the first image, whereby at least part of the structural feature that triggered the at least one reflection is obscured in the first image.

6. An apparatus as claimed in claim 1, the image generation unit being configured to generate the first image to be a two-dimensional or three-dimensional representation of the object and the second image to be a one-dimensional or two-dimensional representation of the object.

7. An apparatus as claimed in claim 1, the analysis unit being configured to detect, at a particular location on the object's surface, multiple reflections of the one or more transmitted sound pulses, the image generation unit being configured to generate the first image using fewer of those multiple reflections than the second image.

8. An apparatus as claimed in claim 7, the image generation unit being configured to generate the first image using on only one of the multiple reflections.

9. An apparatus as claimed in claim 7, the image generation unit being configured to generate the first image using the reflection, of the multiple reflections, that has the highest amplitude.

10. An apparatus as claimed in claim 7, the image generation unit being configured to generate the second image using two or more of the multiple reflections.

11. An apparatus as claimed in claim 1, the image generation unit being configured to generate the first and second images using reflections received at the apparatus during a respective time range, the second image's respective time range being shorter than the first image's respective time range.

12. An apparatus as claimed in claim 1, the image generation unit being configured to select reflections to use in generating the first and second images in dependence on a user input.

13. An apparatus as claimed in claim 1, the image generation unit being configured to generate the second image to represent a relative depth at which each of the reflections used to generate the image was triggered in the object.

14. An apparatus as claimed in claim 1, comprising a receiver surface for receiving signals comprising reflections of the one or more transmitted sound pulses, the image generation unit being configured to associate each pixel in the first and/or second image with a location on the receiver surface.

15. An apparatus as claimed in claim 14, the image generation unit being configured to select a colour for a pixel in dependence on an ultrasound signal feature associated with a reflection received at that pixel's associated location.

16. An apparatus as claimed in claim 2, the ultrasound signal feature being one or more of a time-of-flight, amplitude and/or phase associated with the reflection.

17. An apparatus as claimed in claim 14, the image generation unit being configured to, if a pixel represents a reflection that has an amplitude below a threshold value, associate that pixel with a predetermined value.

18. An apparatus as claimed in claim 17, the predetermined value being above the amplitude of the reflection represented by the pixel.

19. An apparatus as claimed in claim 17, the threshold being adjustable by the user.

20. An apparatus as claimed in claim 17, the image generation unit being configured to set any pixel associated with the predetermined value to be a colour comprised within a particular colour range in the image.

21. An apparatus as claimed in claim 21, the particular colour range being grayscale.

22. An apparatus as claimed in claim 1, the apparatus comprising a user input module configured to receive a user input selecting one or more pixels in the first image, the image generation unit being configured to generate the second image in dependence on reflections received at the locations on the receiver surface corresponding to the selected pixels.

23. An apparatus for imaging structural features below the surface of an object, comprising:
a transmitter unit configured to transmit a sound pulse at the object;
a receiver unit configured to receive one or more reflections of that sound pulse from the object;
an analysis unit configured to determine a time-of-flight and an amplitude of each of the one or more reflections; and
an image generation unit configured to:
identify time-of-flights and amplitudes of reflections received from a particular location on the object's surface; and
generate an image in dependence on the identified time-of-flights and amplitudes that represents, for each reflection received from the particular location, the amplitude of that reflection and a relative depth below the particular point at which that reflection was triggered in the object.

24. An apparatus as claimed in claim 20, the image generation unit being configured to determine the particular location in dependence on user input.

25. An apparatus as claimed in claim 20, the image generation unit being configured to generate a plot of an indication of the amplitude of the reflections received at the particular location against an indication of the relative depths of those reflections.

26. An apparatus for imaging structural features below the surface of an object, comprising:
a transmitter unit configured to transmit a sound pulse at the object;
a receiver unit configured to receive one or more reflections of that sound pulse from the object;
an analysis unit configured to determine a time-of-flight and an amplitude of each of the one or more reflections; and
an image generation unit configured to:
identify time-of-flights and amplitudes of reflections received from a particular line across the object's surface; and
generate an image in dependence on the identified time-of-flights and amplitudes, said image representing the variation in amplitude of the reflections received from the particular line and the relative depths below the particular line at which those reflections were triggered.

27. An apparatus for imaging structural features below the surface of an object, comprising:
a transmitter unit configured to transmit a sound pulse at the object;
a receiver unit configured to receive one or more reflections of that sound pulse from the object;
an analysis unit configured to determine a time-of-flight and an amplitude of each of the one or more reflections; and
an image generation unit configured to:
receive a user input that defines a time-of-flight range;
identify the amplitudes of reflections that have a time-of-flight in the defined range; and
generate a three-dimensional image of a section of the object in dependence on reflections that have those identified amplitudes.

28. An apparatus as claimed in claim 27, the image generation unit being configured to generate the three-dimensional image in dependence on the identified amplitudes.

29. An apparatus as claimed in claim 27, the image generation unit being configured to generate the three-dimensional image in dependence on the time-of-flights of the reflections having the identified amplitudes.

30. An apparatus as claimed in claim 1, configured to simultaneously display two or more different images of the object.

31. A method for imaging structural features below the surface of an object, comprising:
gathering information about structural features located at different depths below the surface of the object by transmitting one or more sound pulses at the object and detecting reflections of those sound pulses from the object;
generating a first image in dependence on a first subset of the detected reflections, the first image representing an overview in which one or more of the structural features may be obscured by another of the structural features; and
generating a second image in dependence on a second subset of the detected reflections, the second image representing a slice through the first image whereby the obscured structural features can be uncovered.
